(19) United States
(12) Patent Application Publication
(10) Pub. No.: US 2024/0143702 A1
(43) Pub. Date: May 2, 2024

(54) MACHINE LEARNING ALGORITHM SELECTION

(71) Applicant: Fujitsu Limited, Kawasaki-shi (JP)

(72) Inventors: Mehdi BAHRAMI, Sunnyvale, CA (US); Wei-Peng CHEN, Sunnyvale, CA (US); Mukul PRASAD, Sunnyvale, CA (US)

(73) Assignee: Fujitsu Limited, Kawasaki-shi (JP)

(21) Appl. No.: 17/977,941

(22) Filed: Oct. 31, 2022

(51) Int. Cl. G06K 9/62

(52) U.S. Cl. CPC G06K 9/6227; G06K 9/6228; G06K 9/6265

(57) ABSTRACT

A method of machine learning algorithm selection may include obtaining a dataset that includes multiple data entries. In some embodiments, each of the data entries may include multiple features and one of the multiple features may be designated as a target variable. The method may further include selecting a subset of the data entries. In some embodiments, selecting the subset of the data entries may include binning the data entries into multiple data bins based on values in the target variable and selecting a subset of the binned data entries from each of the multiple data bins as the subset of the data entries. The method may further include constructing multiple machine learning models using the subset of the data entries and selecting one of the multiple machine learning models based on an evaluation of the multiple machine learning models.

### FIELD

The embodiments discussed in the present disclosure are related to machine learning algorithm selection.

### BACKGROUND

Computer software and hardware has evolved to allow for machine learning to become more and more prevalent in all different types of industries. As a result, multiple different machine learning algorithms have been development for a variety of different applications.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an example embodiment, a method of machine learning algorithm selection may include obtaining a dataset that includes multiple data entries. In some embodiments, each of the data entries may include multiple types and one of the multiple features may be designated as a target variable. The method may further include selecting a subset of the data entries. In some embodiments, selecting the subset of the data entries may include binning the data entries into multiple data bins based on values in the target variable and selecting a subset of the binned data entries from each of the multiple data bins as the subset of the data entries. The method may further include constructing multiple machine learning models using the subset of the data entries and selecting one of the multiple machine learning models based on an evaluation of the multiple machine learning models.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example operational flow for machine learning algorithm selection;

FIG. 2 illustrates a flowchart of an example method of data entry selection;

FIG. 3 illustrates an example diagram of binned data entries used in data entry selection;

FIG. 4 illustrates an example configuration of an ensemble machine learning model;

FIG. 5 illustrates an example diagram of binned data entries used to evaluate machine learning models;

FIG. 6 illustrates a flowchart of an example method of machine learning algorithm selection; and

FIG. 7 illustrates an example system that may be used for machine learning algorithm selection.

### DESCRIPTION OF EMBODIMENTS

Machine learning is the ability of a computer system to be able to learn and adapt without following explicit instructions, by using algorithms and statistical models to analyze and draw inferences from patterns in data. Different types of data may benefit from different types of machine learning algorithms. As a result, multiple different machine learning algorithms have been developed. However, not only have different machine learning algorithms been developed for different types of data, but multiple different types of machine learning algorithms have also been developed for the same type of data. For example, for one type of data, ten or more different machine learning algorithms may be available to develop a machine learning model applicable to the data. Furthermore, in some situations, multiple machine learning models may be combined for a given data type. Thus, it may be difficult to select a machine learning algorithm for particular data.

The system and/or methods described in this disclosure may be configured to help select between different machine learning algorithms to apply to particular data for development of a machine learning model applicable to the particular data. For example, system and/or methods described in this disclosure may provide a manner to evaluate multiple machine learning algorithms to allow for selection therebetween.

Previously evaluating machine learning algorithms for a data set may have been a computational challenge. For example, to evaluate a machine learning algorithm, a model may have been developed and then evaluated using the data set. To develop a more accurate model, larger portions or an entirety of a data set may have been used. Building and/or evaluating models using an entire data set may have been computationally expensive. As a result, building and evaluating models for multiple different machine learning algorithms may be computationally prohibitive.

The system and/or methods described in this disclosure may provide a manner for building and/or evaluating multiple different machine learning algorithms using a subset of a data set. Using a subset of the data set may reduce the computational costs for building and/or evaluating multiple different machine learning algorithms. The subset of the data set may be selected in a manner so that the model being built may more accurately reflect the entirety of the data set and thus may provide a more accurate indication of a model developed using the entire data set. For example, in some embodiments, a subset of a data set may be selected for building and/or evaluating multiple different machine learning algorithms by producing a similar distribution to the original data through binning data entries of the data set into multiple data bins based on values in a target variable of the data set. After binning the data entries, a subset of the binned data entries may be selected from each of the multiple data bins to be used for building and/or evaluating the multiple different machine learning algorithms. Furthermore, the evaluation of the developed models may be performed based on the binning of the data entries.

Thus the system and/or methods described in this disclosure may provide a manner for selecting among multiple different machine learning algorithms that may reduce computational expenses, such as processing time, processing power, memory usage, among other computational expenses. For example, the system and/or methods described in this disclosure may result in savings of computation time up to or more than 70%. As a result, the system and/or methods described in this disclosure may reduce a carbon footprint as compared to current practices. Thus, the system and/or methods described in this disclosure provide a novel technical solution to the technical problem of machine learning algorithm selection. Thus, the system and/or methods described in this disclosure provide a practical application with respect to machine learning algorithm selection that provides a meaning advancement in the technology of machine learning.

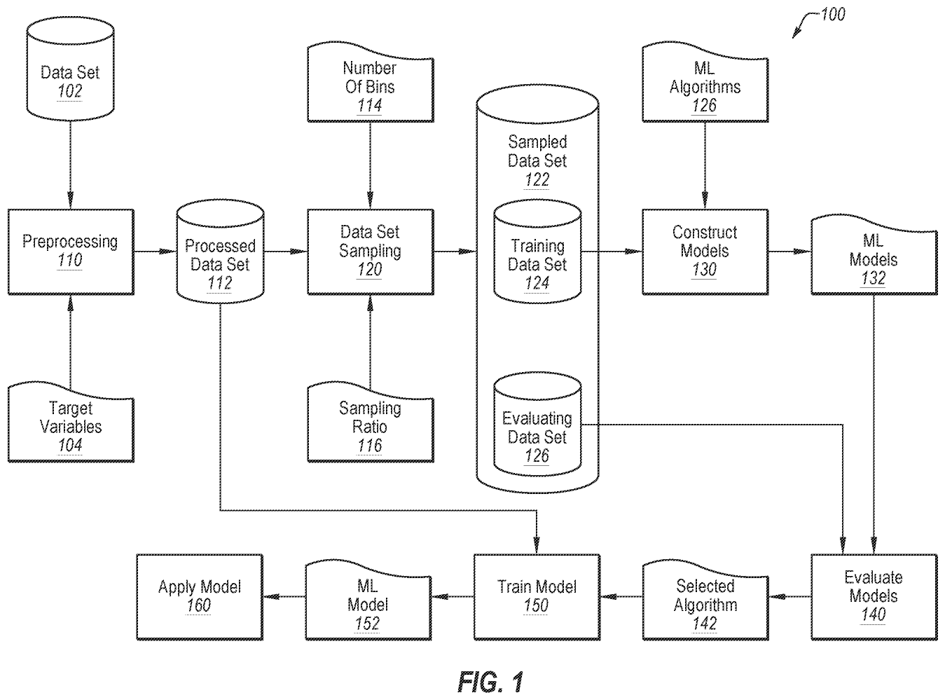

Turning to the figures, FIG. 1 illustrates an example operational flow 100, according to at least one embodiment in the present disclosure. The operational flow 100 may illustrate an operational flow for machine learning algorithm selection. For example, the operational flow 100 may include multiple operations that may be configured to select a particular machine learning algorithm from among multiple machine learning algorithms for a data set 102.

In some embodiments, the data set 102 may include multiple data entries and each of the data entries may include multiple features of one or more feature types. For example, the data set 102 may include a tabular data set. The tabular data set may include multiple different columns and rows. Each of the columns may represent a feature of any one of different feature types, such as categorical, text, numerical, mixed value, etc. A data entry may be assigned to each row and a data entry may or may not include a value in each of the columns that corresponds to the features. As an example, the data set may relate to real estate. Each data entry in the data set 102 and thus each row, may correspond to a different piece of real estate, such as a residential property. The features may include features of real estate, such as, a location, a size, does the real estate include a building, type of building, size of the building, access to utilities, recent selling price, current valuation, access to public transportation, crime rates, etc. Based on the above example, for a piece of real estate with a home, a value may be provided for all of the features. Alternatively, for a piece of real estate that is undeveloped, a value may not be provided for all of the features.

In some embodiments, one or more target variables 104 may be obtained. The target variables 104 may be features for which a machine learning model may be trained. For example, the target variables 104 may be any feature for which a machine learning model may predict a value based on other values of features. As an example, the target variable 104 may be a current valuation of real state. In these and other embodiments, a machine learning model may be trained to predict the current valuation of a piece of real estate based on values from other features about the piece of real estate provided to the machine learning model.

In some embodiments, at operation 110 the data set 102 may be preprocessed. Preprocessing of the data set 102 may be include preparing the data set 102 to be used for training and evaluating a machine learning model. In some embodiments, preprocessing of the data set 102 may include removing one or more data entries and/or feature types, adjusting values, changing text to values, including other data conditioning processes. The operation 110 may generated a processed data set 112.

In some embodiments, at operation 120 a sampling of the processed data set 112 may be performed. The sampling of the processed data set 112 may including selecting a subset of the data entries of the processed data set 112 as a sampled data set 122. The sampled data set 122 may include data entries that may be used to train and/or evaluate a machine learning algorithm for the data set 102.

In some embodiments, selecting the subset of the data entries of the processed data set 112 may include multiple operations. For example, selecting the subset of the data entries may include binning the data entries into multiple data bins based on values in the target variable of the data entries. In these and other embodiments, the operation may bin the data entries based on an obtained number of bins 114. The number of bins 114 may be obtain from or based on user input. Alternately or additionally, the number of bins 114 may be based on a number of the features and/or quantitatively determined based on results from previous iterations of the operational flow 100.

In some embodiments, a subset of the binned data entries from each of the multiple data bins may be selected as the data entries in the sampled data set 122. In these and other embodiments, a number of the data entries selected from each of the data bins may be based on a sampling ratio 116. For example, for a sampling ratio 116 of 0.3, three of every ten data entries from a data bin may be selected for inclusion in the sampled data set 122. In some embodiments, the data entries may be randomly selected from the data bins. In some embodiments, the sampling ratio 116 may be obtain from or based on user input. Alternately or additionally, the sampling ratio 116 may be based on a number of the features, may be quantitatively determined based on results from previous iterations of the operations flow 100, and/or may be based on a number of machine learning algorithms being evaluated by the operational flow 100.

In some embodiments, the target variables 104 may include multiple target features categories, such as a first target variable and a second target variable. In these and other embodiments, the operation 110 may include binning the data entries into multiple first data bins based on values in the first target variable of the data entries and binning the data entries into multiple second data bins based on values in the second target variable of the data entries.

In these and other embodiments, the operation 110 may further include determining data bins of the first data bins that correspond to data bins from the second data bins. A data bin from the first data bins may correspond to a bin from the second data bins based on the bins having a same or similar positional relationship among the bins. For example, a first data bin of the first data bins may be a data bin that is directly adjacent to a data bin with the lowest values and a second data bin of the second data bins may be a data bin that is directly adjacent to a data bin with the lowest values. As such, the first data bin may correspond to the second data bin.

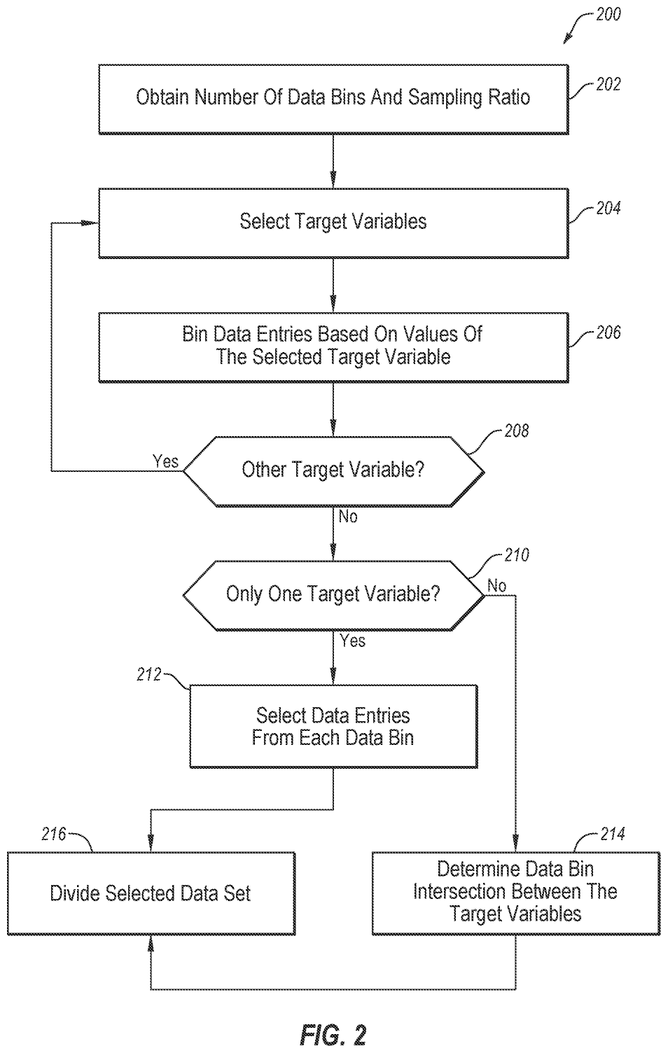

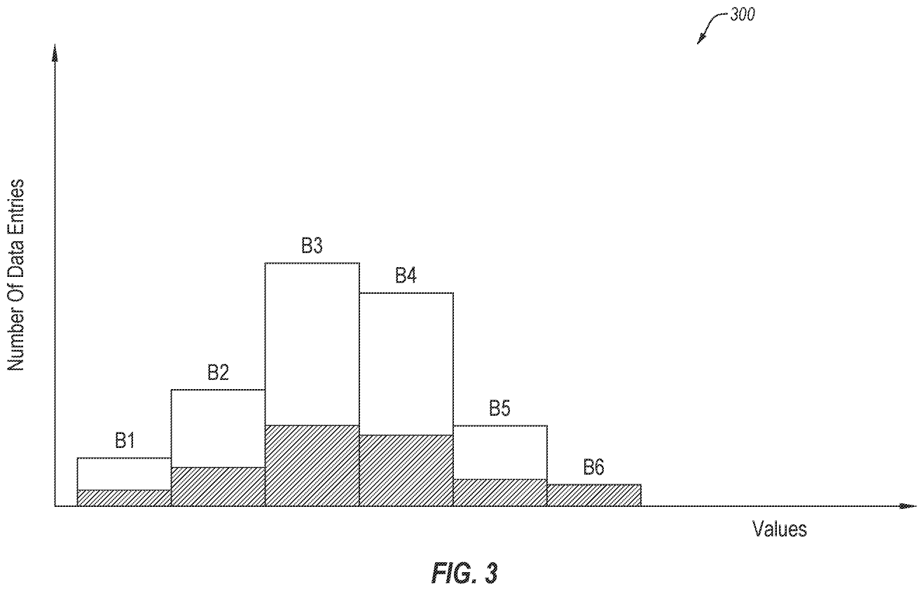

In these and other embodiments, the operation 110 may further include determining data entries that are in corresponding bins as union data entries. For example, a data entry that is in the first data bin of the first data bins and the second data bin of the second data bins may be a union data entry. In these and other embodiments, selecting the subset of the data entries of the processed data set 112 for the sampled data set 122 may include selecting a subset of the union data entries from each of the corresponding data bins as the sampled data set 122. FIGS. 2 and 3 further describe selection of a sampled data set from a data set.

In some embodiments, the sampled data set 122 may be divided into a training data set 124 and an evaluating data set 126. In these and other embodiments, the sampled data set 122 may be divided by dividing the data entries in each of the data bins to create the training data set 124 and the evaluating data set 126. For example, the sampled data set 122 may be divided such that the training data set 124 includes an equal or approximately percentage of the data entries from each of the data bins and the evaluating data set 126 includes an equal or approximately percentage of the data entries from each of the data bins.

As an example, the sampled data set 122 may include three data bins that each include four data entries. The training data set 124 may include 75 percent of the data entries from each of the data bins, i.e., three data entries from each of the three bins, and the evaluating data set 126 may include 25 percent of the data entries from each of the three data bins, i.e., one data entry from each of the three data bins. In these and other embodiments, the percent of the data bins to assign to the training data set 124 and the evaluating data set 126 may be from or based on user input. Alternately or additionally, the percent of the data bins to assign to the training data set 124 and the evaluating data set 126 may be based on a number of the features, on results from previous iterations of the operations flow 100, and/or a number of machine learning algorithms being evaluated by the operational flow 100.

In some embodiments, at operation 130, the training data set 124 and machine learning algorithms 128 to be evaluated may be used to construct machine learning models 132. In these and other embodiments, a number of and types of the machine learning algorithms 128 to be evaluated may be based on the data included in the data set 102 and/or the target variables 104. The number of machine learning algorithms 128 to be evaluated may be based on the number of machine learning algorithms that are configured to be applied to the type of data in the data set 102 and/or the type of data in the target variables 104. Alternately or additionally, the number of machine learning algorithms 128 to be evaluated may be based on the operational flow 100, such as a processing power, processing time, or other limitations of the device or system configured to perform the operational flow 100. In these and other embodiments, the number of machine learning algorithms 128 to be evaluated may range between two and a thousand.

In some embodiments, one or more of the machine learning models 132 may be constructed for each of the machine learning algorithms 128 to be evaluated. For example, the training data set 124 may be provided to one of the machine learning algorithms 128 to generate a machine learning model that corresponds to the one of the machine learning algorithms 128. In these and other embodiments, the machine learning models 132 may be trained to predict or determine a value for each of the target variables 104 given values for others features in the data set 102.

In some embodiments, a machine learning model that is generated using a single one of the machine learning algorithms 128 may be referred to in this disclosure as singular machine learning model. In these and other embodiments, the training data set 124 is applied to single one of the machine learning algorithms 128 to generate a singular machine learning model. In these and other embodiments, one or more of the machine learning models 132 may be singular machine learning models.

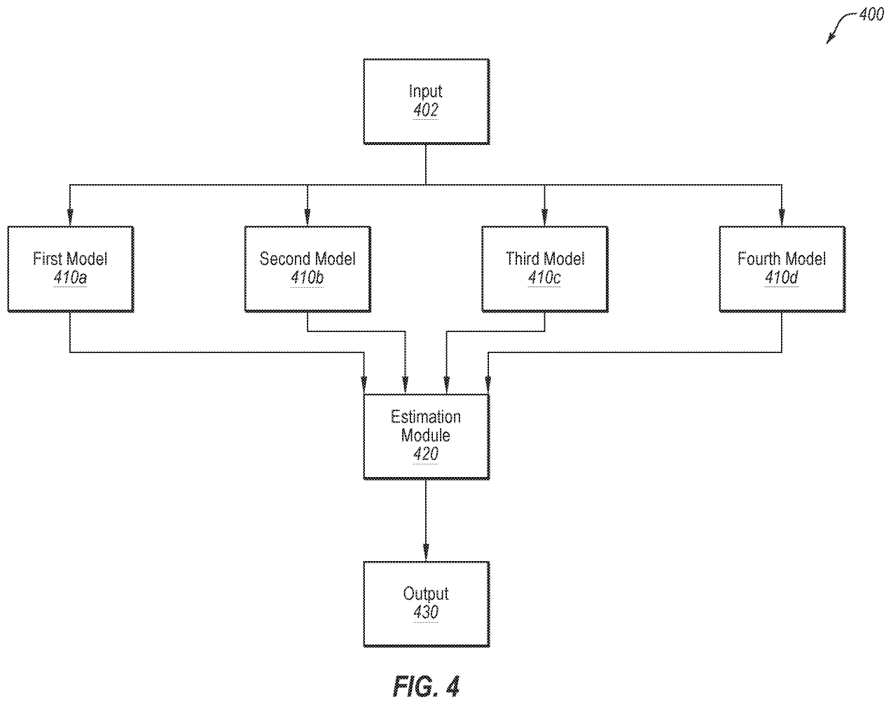

Alternately or additionally, a machine learning model may be constructed during the operation 130 based on multiple of the machine learning algorithms 128. The machine learning model generated based on multiple of the machine learning algorithms 128 may be referred to in this disclosure as ensemble machine learning models. For example, the ensemble machine learning models may be constructed by mathematically combining the outputs from multiple of the singular machine learning models. FIG. 4 illustrates an example configuration of an ensemble machine learning model. In some embodiments, the machine learning models used to construct the ensemble machine learning models may be randomly selected. Alternately or additionally, the singular machine learning models may be evaluated in operation 140 and the higher performing singular machine learning models may be used to construct the ensemble machine learning models. Alternately or additionally, one or more different ensemble machine learning models and/or singular machine learning models may be used to construct another ensemble machine learning model.

In some embodiments, the machine learning models 132 may include one or more ensemble machine learning models. In these and other embodiments, the difference between the ensemble machine learning models may be based on how the ensemble machine learning models combine the outputs from the machine learning modules included in the ensemble machine learning model.

In some embodiments, the machine learning models 132 constructed during operation 130 may include more models than the machine learning algorithms 128 includes algorithms based on a number of ensemble machine learning models included in the machine learning models 132. For example, when the machine learning models 132 include no ensemble machine learning models, the machine learning models 132 may include a same number of models as algorithms in the machine learning algorithms 128. In these and other embodiments, the machine learning models 132 may include any combination of ensemble and singular machine learning models.

In some embodiments, at operation 140 the machine learning models 132 may be evaluated using the evaluating data set 126. In these and other embodiments, the machine learning models 132 may be evaluated using the evaluating data set 126 and a scoring algorithm. To evaluate the machine learning models 132, the values of the features categories other than the target variables 104 of the machine learning models 132 may be provided to the machine learning models 132. The machine learning models 132 may generate values for the target variables 104. For example, for a data entry, values of the features other than the target variables 104 of the data entry may be provided to one of the machine learning models 132. The one of the machine learning models 132 may generate values for the target variables 104.

In these and other embodiments, the calculated values of the target variables 104 and the actual values of the target variables 104 may be used along with the scoring algorithm to evaluate the machine learning models 132.

In some embodiments, the scoring algorithm may use two inputs to generate a score for each of the machine learning models 132. The scores of the machine learning models 132 may allow the machine learning models 132 to be evaluated. In these and other embodiments, the machine learning models 132 may be ranked according to the scores with the higher-ranking machine learning models 132 indicating that these machine learning models 132 more accurately predicted values for the target features than other of the machine learning models 132.

In some embodiments, a first input to the scoring algorithm may be a bin error distance. A bin error distance may be calculated for each of the data entries in the evaluating data set 126. A bin error distance may represent a number of data bins between a data bin of the actual value of the target variables 104 as assigned during operation 120 and a data bin of a calculated value of the target variables 104. For example, the evaluating data set 126 may include four data bins for values of the target variables 104. For a data entry, the actual value of the target variables 104 may be in the second data bin and the calculated value of the target variables 104 may be such that it would be located in the fourth data bin. As such, the bin error distance would be two based on a difference between the fourth data bin and the second data bin.

In some embodiments, a second input to the scoring algorithm may be a value assigned to the data bins of the actual values of the target variables 104. In these and other embodiments, the value assigned may be based on a probability density function applied to values of the target variables 104 of the evaluating data set 126 based on the binning of the data entries during operation 120. For example, a probability density function may indicate a probability that any one data entry may include a value of the target variables 104 within a particular data bin. For example, the evaluating data set 126 may include four data bins for values of the target variables 104. A first data bin may have a probability of 15 percent that a value of the target variable 104 of a data entry is in the first data bin. Each of the other data bins may also have a probability. In these and other embodiments, the second score for a data entry may be the probability associated with a data bin that includes the actual value of the target variables 104 of the data entry.

Alternately or additionally, the value assigned may be based on a number of the data entries in each data bin as assigned during operation 120. In these and other embodiments, the second score for a data entry may be the number of data entries in the data bin that includes the actual value of the target variables 104 of the data entry.

In some embodiments, a first input and a second input may be provided to the scoring algorithm for each of the data entries in the evaluating data set 126. In these and other embodiments, the scoring algorithm may determine a score for each of the data entries in the evaluating data set 126 based on the first input and the second input for the data entries. In some embodiments, the score for a data entry may be the second input when the bin distance is zero, that is when the bin of the actual value of the target variables 104 and the bin of a calculated value of the target variables 104 are the same. In these and other embodiments, when the bin distance is not zero the score for a data entry may be negative and may be a mathematical combination of the second input and the first input, that is when the bin of the actual value of the target variables 104 and the bin of a calculated value of the target variables 104 are not the same. In these and other embodiments, the score for a machine learning model may be a summation of the individual scores assigned to each of the data entries in the evaluating data set 126.

For example, the score for a machine learning model may be represented by the following equations:

$${𝔼}_{X} ( {y}_{i} ) = \{ \begin{matrix}𝔻 ( {y}_{i} ) & {β}_{i} \leq \hat{y} < {β}_{i + 1} \\ - 𝔻 ( {y}_{i} ) * ‖ {β}_{i} - {\hat{β}}_{i} ‖ & \hat{y} < {β}_{i} or \hat{y} > {β}_{i + 1}\end{matrix}$$

$$ℳ = {arg max}_{θ} ( {\sum }_{i = 1}^{Γ} {𝔼}_{X} ( {y}_{i} )$$

In these equations, yᵢ may be a data entry in the evaluating data set 126, ŷ may be the calculated value of the target variable for the data entry, Bᵢ may be the bin number associated with the data entry when calculating the bin error distance and values in the bins when comparing to the calculated value ŷ, D(yᵢ) may be a density of the bin Bᵢ of the data entry yᵢ, where the density may be the second score discussed above, \hat{B}ᵢ may be the bin number of the calculated value ŷ, ∥Bᵢ−\hat{B}ᵢ∥ may be the bin error distance, Eₓ(yᵢ) may be an individual score assigned to each of the data entries yᵢ, Γ may be the number of data entries in the evaluating data set 126, and M may be a score for the machine learning model.

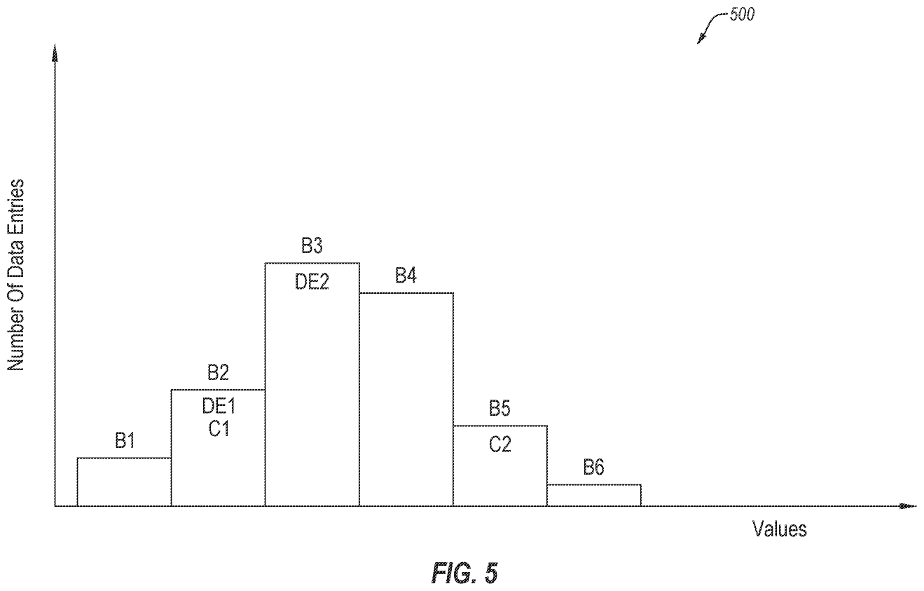

FIG. 5 illustrates an example diagram 500 of binned data entries used to evaluate machine learning models, according to at least one embodiment in the present disclosure. The diagram 500 includes an x-axis that corresponds to values of a target variable and a y-axis that corresponds to the number of data entries. The diagram 500 includes a first data bin B1, a second data bin B2, a third data bin B3, a fourth data bin B4, a fifth data bin B5, and a sixth data bin B6. The data bins may be based on data bins constructed when the data entries are selected for inclusion in a sampled data set, such as during the operation 120 of FIG. 1. The height of the data bins may correspond to the number of data entries in each data bin. As such, the third data bin B3 may include more data entries than the other data bins resulting from more data entries in the data set including values in the target variable that are within the range of the third data bin B3.

The diagram 500 further illustrates a first data entry DE1 in the second data bin B2 based on a value of the target variable of the first data entry DE1 being in the second data bin B2. The diagram further illustrates a first calculated value C1 of the target variable of the first data entry DE1. The first calculated value C1 may be a value that is generated by a machine learning model based on the values of the feature types of the first data entry DE1. The first calculated value C1 may have a value within a range such that it is binned in the second data bin B2. Because the first data entry DE1 and the first calculated value C1 are in the same bin, a score for evaluating the machine learning model that generated the first calculated value C1 based on the first data entry DE1 may be the second score. In these and other embodiments, the second score may be the number of data entries in the second data bin B2.

The diagram 500 further illustrates a second data entry DE2 in the third data bin B3 based on a value of the target variable of the second data entry DE2 being in the third data bin B3. The diagram further illustrates a second calculated value C2 of the target variable of the second data entry DE2. The second calculated value C2 may be a value that is generated by a machine learning model based on the values of the features of the second data entry DE2. The second calculated value C2 may have a value within a range such that it is binned in the fifth data bin B5. Because the second data entry DE2 and the second calculated value C2 are not in the same bin, a score for evaluating the machine learning model that generated the second calculated value C2 based on the second data entry DE2 may be negative and may be a mathematical combination of the second input and the first input. In these and other embodiments, the score may be a mathematical combination of the bin distance, which may be two, and the number of data entries in the third data bin B3 based on the second data entry DE2 belonging to the third data bin B3. In these and other embodiments, if the same machine learning model generated both the first and second calculated values C1 and C2, the score for the machine learning model may be a summation of the individual scores for the first data entry DE1 and the second data entry DE2.

In some embodiments, the machine learning model 132 with the high score may be determined as the selected machine learning algorithm 142. The selected machine learning algorithm 142 may be the one of the machine learning models 132 that is determined by the operational flow 100 to determine values more accurately for the target variables 104 using the other features of the data set 102.

In some embodiments, at operation 150 a machine learning model 152 may be trained using the selected machine learning algorithm 142. In these and other embodiments, the machine learning model 152 may be trained using the processed data set 112, the sampled data set 122, or the training data set 124.

In some embodiments, at operation 160 the machine learning model 152 may be applied to another data set that includes one or more of the other features and does not include values for the target variables 104. The machine learning model 152 may be applied to a data set that is similar to the data set 102. In these and other embodiments, the operational flow 100 may allow for selection of a machine learning algorithm that may perform better than other machine learning algorithms for a particular data set. In addition, the operational flow 100 may allow for selection of a machine learning model with reduced processing time and/or processing power. Thus, the operational flow 100 may provide benefits in the technical field of machine learning and may reduce the computation complexity of machine learning algorithms.

Modifications, additions, or omissions may be made to the operational flow 100 without departing from the scope of the present disclosure. For example, in some embodiments, the operational flow 100 may include additional operations or fewer operations. For example, the operational flow 100 may not include the operation 110.

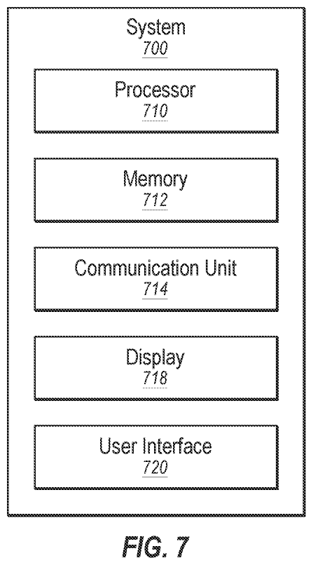

FIG. 2 illustrates a flowchart of an example method 200 of data entry selection. The method 200 may be arranged in accordance with at least one embodiment described in the present disclosure. One or more operations of the method 200 may be performed, in some embodiments, during an operation flow, such as the operational flow 100 of FIG. 1 or by a system, such as the system 700 of FIG. 7 or another system, combination of devices, system, or systems. In these and other embodiments, the method 200 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method may begin at block 202, where a number of data bins and a sampling ratio may be obtained. The number of data bins and the sampling ratio may be used to select data entries from a data set. The selected data entries may be used to build and/or evaluate machine learning models from one or more machine learning algorithms.

The number of data bins and the sampling ratio may be obtained from user input. Alternately or additionally, the number of data bins and the sampling ratio may be determined based on user input, the data set, target features in the data set, other information, or some combination thereof.

At block 204, a target variable of the data set may be selected. The target variables may be the features predicted by the machine learning models being built and evaluated. Each of the data entries may have a value in each of the target variables. The values for the selected target variable may span a range of values that may be determined based on the selected target variable.

At block 206, data entries may be binned based on the values of the selected target variable of the data entries. The number of data bins into which the data entries may be binned may be based on the obtained number of data bins. In some embodiments, each of the data bins may have a similar or the same range. To determine a range for one data bin, the range of the values for the selected target variable may be determined and divided by the number of data bins. A data entry may be assigned to a data bin that includes a range in which the value of the data entry of the selected target variable is found. For example, the values of the selected target variable may range from 5 to 20 and there may be four data bins, such that the first data bin ranges from 5-8, the second data bin ranges from 9-12, the third data bin ranges from 13-16, and the fourth data bin ranges from 17-20. Thus, a data entry with a value of 14 in the selected target variable may be binned in the third data bin.

At block 208, it may be determined if there is another target variable in the data set. In response to there not being another target variable in the data set, the method 200 may proceed to block 210. In response to there being another target variable in the data set, the method 200 may proceed back to block 204. In block 204, another target variable may be selected. In block 206, the data entries may be binned again based on the range of values for the other target variable. The binning again may not change the binning previously performed. Rather, multiple sets of data bins may be created, one for each target variable, and all of the data entries may be binned in each set of data bins.

At block 210, it may be determined if there is only one target variable in the data set. In response to there being only one target variable in the data set, the method 200 may proceed to block 212. In response to there being more than one target variable in the data set, the method 200 may proceed to block 214.

At block 212, a data entries may be selected from each data bin. The selected data entries may be used to build and/or evaluate machine learning algorithms. The number of data entries selected from each data bin may be based on the sampling ratio. For example, for a sampling ratio of 3/10, three of every ten data entries in a data bin may be selected. The data entries may be selected randomly from the data bins. When a number of data entries in a data bin does not allow to adhere to the ratio the number of data entries may be round up or down. In some embodiments, the number of data entries may be lower than the sampling ratio, such as when the number of data entries is zero, one, two, three, four, five, six, or seven. In response to the number of data entries being lower than the sampling ratio, the data entry in the data bin may be selected to provide better coverage for the machine learning models. As a result, a data entry that is the only data entry in a data bin may be selected. As another example, for a data bin with two data entries, both of the data entries may be selected.

FIG. 3 illustrates an example diagram 300 of binned data entries used in data entry selection, according to at least one embodiment in the present disclosure. The diagram 300 includes an x-axis that corresponds to values of a target variable and a y-axis that corresponds to the number of data entries. The diagram 300 includes a first data bin B1, a second data bin B2, a third data bin B3, a fourth data bin B4, a fifth data bin B5, and a sixth data bin B6. The height of the data bins may correspond to the number of data entries in each data bin. As such, the third data bin B3 may include more data entries than the other data bins resulting from more data entries in the data set including values in the target variable that are within the range of the third data bin B3.

The diagram 300 further illustrates a number of data entries selected from each data bin. The selected data entries may be represented by the crosshatch pattern within the data bins. As illustrated, approximately 30% of each of the data bins may be selected. Note that more than 30% of the data entries in the sixth data bin may be selected based on the low number of data entries in the sixth data bin. Thus, a distribution of values of the selected data entries in the selected target variable may be approximately the same, the same, or similar to the distribution of values in the selected target variable of the entire data set.

Returning to the method 200, at block 214, data bin intersection between the target variables may be determined. As discussed above, for each target variable a set of data bins may be created. In these and other embodiments, each set of data bins may include the same number of data bins. For example, each set of data bins may include data bins numbered between 1 and 10. In these and other embodiments, the data bins with corresponding numbers may be considered corresponding data bins. The data bins may include corresponding numbers because each data bin set may select the data bin with the lowest values as the first data bin and the data bin with the highest values as the last data bin with the data bins numbered consecutively therebetween or vice-versa. Thus, corresponding data bins from different data bin sets may include values that correspond based on the values relationship to other values in the other data bins in the data bin sets. For example, first data bins in different data bin sets may each include the lowest values and last data bins in different data bin sets may include the highest values.

In some embodiments, to determine data bin intersection, the data entries that are in corresponding data bins of each data bin set may be identified as union data entries. Thus, for a data entry to be identified as a union data entry, the data entry may be binned in corresponding data bins and not binned in non-corresponding data bins. Thus, if a data entry is binned in data bins in different data bin sets and the data bins do not correspond, the data entry may not be identified as a union data entry.

For example, a data entry in a first data bin of a first data bin set and in a first data bin of a second data bin set where the first data bins correspond, the data entry may be identified as a union data entry. In contrast, a data entry in the first data bin of the first data bin set and in second data bin of a second data bin where the first data bin does not correspond to the second data bin, the data entry may not be identified as a union data entry.

Thus, for a data entry to be identified as a union data entry, the data entry may be binned in corresponding bins for each set of data bins generated. For example, for three target variables, three data bin sets may be generated. Thus, union data entries may be binned in corresponding data bins in each of the three data bin sets and not binned in non-corresponding data bins across the three data bin sets.

In some embodiments, after identifying the union data entries in each of the data bins of the data bin sets, union data bin entries may be selected from each group of corresponding data bins from the data bin sets as described with respect to block 212. For example, the number of union data entries selected from each group of corresponding data bins may be based on the sampling ratio. For example, if there are ten union data entries in the corresponding group of first data bins, then the number of union data entries selected from the corresponding group of first data bins based on the sampling ratio of 3/10 may be three. The selected union data entries may be the selected data set resulting from block 212.

At block 216, the selected data set may be divided. For example, the selected data set may be divided into a training data set and an evaluating data set. In these and other embodiments, the selected data set may be divided by dividing the data entries in each of the data bins to create the training data set and the evaluating data set. For example, the selected data set may be divided such that the training data set includes an equal or approximately percentage of the data entries from each of the data bins and the evaluating data set includes an equal or approximately percentage of the data entries from each of the data bins.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

FIG. 4 illustrates an example configuration of an ensemble machine learning model 400, according to at least one embodiment in the present disclosure. The ensemble machine learning model 400 may be a combination of one or more singular machine learning models or one or more ensemble machine learning models.

As illustrated, the ensemble machine learning model 400 may include a first model 410a, a second model 410b, a third model 410c, and a fourth model 410d, referred to collectively as the models 410. The ensemble machine learning model 400 may include more or fewer models than the four illustrated. Each of the models 410 may be a singular machine learning model or an ensemble machine learning models. As an example, the singular machine learning models may be one of the following types of machine learning models: Random Forest, Extreme gradient boosting, Linear regression, Logistic regression, Decision tree, Support vector machine, Naive Bayes, k-nearest neighbor, K-means, Dimensionality reduction algorithms, Gradient boosting, and AdaBoosting, among other.

In some embodiments, any machine learning model may be selected to construct the ensemble machine learning model 400. Alternately or additionally, machine learning models may be selected to include in the ensemble machine learning model 400 based on an evaluation of multiple different machine learning models. In these and other embodiments, higher evaluated machine learning models may be selected for inclusion in the ensemble machine learning model 400. For example, the four best machine learning models based on an evaluation as discussed in this disclosure may be selected for inclusion in the ensemble machine learning model 400.

In some embodiments, the ensemble machine learning model 400 may include an input module 402 that may take a data entry and provide values from different features categories to each of the models 410. Each of the models 410 may generate a value for each of one or more target variables based on how the models 410 are built. The models 410 may output the values to an estimation module 420.

In some embodiments, the estimation module 420 may be configured to mathematically combine the values from each of the models 410 to generate an output 430. The estimation module 420 may mathematically combine the values based on mean, medium, weighted mean, or some other mathematical combination of the values. Alternately or additionally, the estimation module 420 may select from among the values from the models 410 or select from among the values and mathematically combine the selected values to generate the output 430.

In some embodiments, the ensemble machine learning model 400 may be varied by varying the estimation module 420. For example, a different estimation module 420 may be used to generate a different ensemble machine learning model 400 even when the models 410 used in the different ensemble machine learning models 400 are the same.

Modifications, additions, or omissions may be made to the ensemble machine learning model 400 without departing from the scope of the present disclosure. For example, an ensemble machine learning model 400 may include a different number of the models 410, such as two, three, five, six, ten, or more models. The ensemble machine learning model 400 illustrated in FIG. 4 is just one type of ensemble machine learning model that may be used. Any other type of ensemble machine learning model may be used. For example, sequential, parallel, bagging, bootstrapping, aggregation, boosting, such as gradient boosting and adaboosting, and stacking, among others.

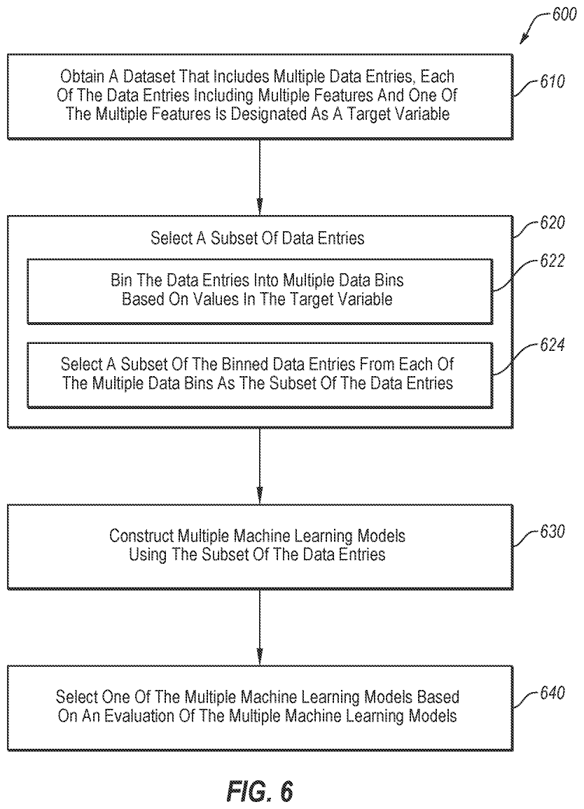

FIG. 6 illustrates a flowchart of an example method 600 of machine learning algorithm selection. The method 600 may be arranged in accordance with at least one embodiment described in the present disclosure. One or more operations of the method 600 may be performed, in some embodiments, during an operation flow, such as the operational flow 100 of FIG. 1 or by a system, such as the system 700 of FIG. 7 or another system, combination of devices, system, or systems. In these and other embodiments, the method 600 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method may begin at block 610, where a dataset may be obtained that includes multiple data entries. In these and other embodiments, each of the data entries may include multiple features and one of the multiple features may be designated as a target variable. At block 620, a subset of the data entries may be selected. The selection of the subset of the data entries may include the blocks 622 and 624.

At block 622, the data entries may be binned into multiple data bins based on values in the target variable. At block 624, a subset of the binned data entries may be selected from each of the multiple data bins as the subset of the data entries.

At block 630, multiple machine learning models may be constructed using the subset of the data entries. In these and other embodiments, one of the multiple machine learning models constructed using the subset of the data entries may include outputs that are a mathematical combination of outputs from multiple different machine learning models that are each generated using a different machine learning algorithm and the subset of the data entries. Alternately or additionally, at least a subset of the multiple machine learning models may each be constructed using a different one of multiple machine learning algorithms. In these and other embodiments, the multiple machine learning algorithms may be selected based on the dataset and the target variable.

At block 640, one of the multiple machine learning models may be selected based on an evaluation of the multiple machine learning models.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiment the method 600 may include training, using the dataset, a particular machine learning model following a type of construction used to construct the selected one of the multiple machine learning models and applying data to the particular machine learning model to predict values of the target variable.

As another example, the target variable may be a first target variable and another of the multiple features may be designated as a second target variable. In these and other embodiments, the method 600 may further include binning the data entries into multiple second data bins based on values in the second target variable. In these and other embodiments, a first bin of the multiple data bins may correspond to a second bin of the multiple second data bins. The method 600 may further include designating data entries as union data entries in response to the data entries including a first value in the first bin and a second value in the second bin. In these and other embodiments, the selecting a subset of the binned data entries from each of the multiple data bins as the subset of the data entries, may include selecting a subset of the binned union data entries from each of the multiple data bins as the subset of the data entries

As another example, the method 600 may further include evaluating the multiple machine learning models using the subset of data entries and a scoring algorithm, wherein an input to the scoring algorithm is a bin error distance representing a number of bins between bins of actual values of the target variable of the subset of the data entries and bins of calculated values of the target variable generated by the multiple machine learning models using values in the other multiple features from the subset of the data entries. In these and other embodiments, a second input to the scoring algorithm may be based on a value assigned to the bins based on a probability density function applied to the subset of the data entries.

In these and other embodiments, a second input to the scoring algorithm may be based on a value assigned to the bins based on a number of the subset of the data entries that include values in each bin. In these and other embodiments, first data entries in the subset of the data entries may be used in the construction of the multiple machine learning models and second data entries in the subset of the data entries may be used in the evaluation of the multiple machine learning models. In these and other embodiments, the first data entries and the second data entries may be selected from among the subset of the data entries based on the data bins into which the first data entries and the second data entries are binned.

FIG. 7 is a block diagram illustrating an example system 700 that may be used for optical signal adjustment, according to at least one embodiment of the present disclosure. The system 700 may include a processor 710, memory 712, a communication unit 716, a display 718, and a user interface unit 720, which all may be communicatively coupled. In some embodiments, the system 700 may be used to perform one or more of the methods described in this disclosure.

For example, the system 700 may be used to perform one or more of the methods described in FIGS. 2 and 6. Alternately or additionally, the system 700 or parts of the system 700 may be used to implement the operational flow 100 of FIG. 1.

Generally, the processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 7, it is understood that the processor 710 may include any number of processors distributed across any number of networks or physical locations that are configured to perform individually or collectively any number of operations described herein. In some embodiments, the processor 710 may interpret and/or execute program instructions and/or process data stored in the memory 712. In some embodiments, the processor 710 may execute the program instructions stored in the memory 712.

For example, in some embodiments, the processor 710 may execute program instructions stored in the memory 712 that are related to task execution such that the system 700 may perform or direct the performance of the operations associated therewith as directed by the instructions. In these and other embodiments, the instructions may be used to perform one or more blocks of method 200 or 600 of FIGS. 2 and 6.

The memory 712 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 710.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 710 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 716 may include any component, device, system, or combination thereof that is configured to transmit or receive information over a network. In some embodiments, the communication unit 716 may communicate with other devices at other locations, the same location, or even other components within the same system. For example, the communication unit 716 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 716 may permit data to be exchanged with a network and/or any other devices or systems described in the present disclosure.

The display 718 may be configured as one or more displays, like an LCD, LED, Braille terminal, or other type of display. The display 718 may be configured to present video, text captions, user interfaces, and other data as directed by the processor 710.

The user interface unit 720 may include any device to allow a user to interface with the system 700. For example, the user interface unit 720 may include a mouse, a track pad, a keyboard, buttons, camera, and/or a touchscreen, among other devices. The user interface unit 720 may receive input from a user and provide the input to the processor 710. In some embodiments, the user interface unit 720 and the display 718 may be combined.

Modifications, additions, or omissions may be made to the system 700 without departing from the scope of the present disclosure. For example, in some embodiments, the system 700 may include any number of other components that may not be explicitly illustrated or described. Further, depending on certain implementations, the system 700 may not include one or more of the components illustrated and described.

As indicated above, the embodiments described herein may include the use of a special purpose or general-purpose computer (e.g., the processor 710 of FIG. 7) including various computer hardware or software modules, as discussed in greater detail below. Further, as indicated above, embodiments described herein may be implemented using computer-readable media (e.g., the memory 712 of FIG. 7) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of machine learning algorithm selection, the method comprising:
obtaining a dataset that includes a plurality of data entries, each of the data entries including a plurality of features and at least one of the plurality of features is designated as a target variable;
selecting a subset of the data entries, the selecting including:
binning the data entries into a plurality of data bins based on values of the target variable; and
selecting a subset of the binned data entries from each of the plurality of data bins as the subset of the data entries;
constructing a plurality of machine learning models using the subset of the data entries; and
selecting one of the plurality of machine learning models based on an evaluation of the plurality of machine learning models.

2. The method of claim 1, further comprising:
training, using the dataset, a particular machine learning model following a type of construction used to construct the selected one of the plurality of machine learning models; and
applying data to the particular machine learning model to predict values of the target variable.

3. The method of claim 1, wherein the target variable is a first target variable and another of the plurality of variables is designated as a second target variable,
the method further comprising:
binning the data entries into a plurality of second data bins based on values of the second target variable, wherein a first bin of the plurality of data bins corresponds to a second bin of the plurality of second data bins; and
designating data entries as union data entries in response to the data entries including a first value in the first bin and a second value in the second bin,
wherein the selecting a subset of the binned data entries from each of the plurality of data bins as the subset of the data entries includes selecting a subset of the binned union data entries from each of the plurality of data bins as the subset of the data entries.

4. The method of claim 1, further comprising evaluating the plurality of machine learning models using the subset of data entries and a scoring algorithm, wherein an input to the scoring algorithm is a bin error distance representing a number of bins between bins of actual values of the target variable of the subset of the data entries and bins of generated values of the target variable generated by the plurality of machine learning models using values in the other plurality of features from the subset of the data entries.

5. The method of claim 4, wherein a second input to the scoring algorithm is based on a value assigned to the bins based on a probability density function applied to the subset of the data entries.

6. The method of claim 4, wherein a second input to the scoring algorithm is based on a value assigned to the bins based on a number of the subset of the data entries that include values in each bin.

7. The method of claim 4, wherein first data entries in the subset of the data entries are used in the construction of the plurality of machine learning models and second data entries in the subset of the data entries are used in the evaluation of the plurality of machine learning models, wherein the first data entries and the second data entries are selected from among the subset of the data entries based on the data bins into which the first data entries and the second data entries are binned.

8. The method of claim 1, wherein one of the plurality of machine learning models constructed using the subset of the data entries includes outputs that are a mathematical combination of outputs from a plurality of different machine learning models that are each generated using a different machine learning algorithm and the subset of the data entries.

9. The method of claim 1, wherein at least a subset of the plurality of machine learning models are each constructed using a different one of a plurality of machine learning algorithms.

10. The method of claim 9, wherein the plurality of machine learning algorithms are selected based on the dataset and the target variable.

11. One or more non-transitory computer-readable storage media configured to store instructions that, in response to being executed, cause or direct a system to perform the method of claim 1.

12. A system comprising:
one or more non-transitory computer-readable storage media configured to store instructions;
one or more processors configured to execute the instructions to cause the system to perform operations, the operations comprising:
obtaining a dataset that includes a plurality of data entries, each of the data entries including a plurality of features and one of the plurality of features is designated as a target variable;
selecting a subset of the data entries, the selecting including:
binning the data entries into a plurality of data bins based on values of the target variable; and
selecting a subset of the binned data entries from each of the plurality of data bins as the subset of the data entries;
constructing a plurality of machine learning models using the subset of the data entries; and
selecting one of the plurality of machine learning models based on an evaluation of the plurality of machine learning models.

13. The system of claim 12, wherein the operations further comprise:
training, using the dataset, a particular machine learning model following a type of construction used to construct the selected one of the plurality of machine learning models; and
applying data to the particular machine learning model to predict values of the target variable.

14. The system of claim 12, wherein the target variable is a first target variable and another of the plurality of features is designated as a second target variable and the operations further comprise:
binning the data entries into a plurality of second data bins based on values in the second target variable, wherein a first bin of the plurality of data bins corresponds to a second bin of the plurality of second data bins; and
designating data entries as union data entries in response to the data entries including a first value in the first bin and a second value in the second bin,
wherein the selecting a subset of the binned data entries from each of the plurality of data bins as the subset of the data entries includes selecting a subset of the binned union data entries from each of the plurality of data bins as the subset of the data entries.

15. The system of claim 12, wherein the operations further comprise evaluating the plurality of machine learning models using the subset of data entries and a scoring algorithm, wherein an input to the scoring algorithm is a bin error distance representing a number of bins between bins of actual values of the target variable of the subset of the data entries and bins of generated values of the target variable generated by the plurality of machine learning models using values in the other plurality of features from the subset of the data entries.

16. The system of claim 15, wherein a second input to the scoring algorithm is based on a value assigned to the bins based on a probability density function applied to the subset of the data entries.

17. The system of claim 15, wherein a second input to the scoring algorithm is based on a value assigned to the bins based on a number of the subset of the data entries that include values in each bin.

18. The system of claim 15, wherein first data entries in the subset of the data entries are used in the construction of the plurality of machine learning models and second data entries in the subset of the data entries are used in the evaluation of the plurality of machine learning models, wherein the first data entries and the second data entries are selected from among the subset of the data entries based on the data bins into which the first data entries and the second data entries are binned.

19. The system of claim 12, wherein one of the plurality of machine learning models constructed using the subset of the data entries includes outputs that are a mathematical combination of outputs from a plurality of different machine learning models that are each generated using a different machine learning algorithm and the subset of the data entries.

20. The system of claim 12, wherein at least a subset of the plurality of machine learning models are each constructed using a different one of a plurality of machine learning algorithms.
